(19) United States
(12) Patent Application Publication
(10) Pub. No.: US 2004/0141830 A1
(43) Pub. Date: Jul. 22, 2004

(54) Pasting and bookbinding apparatus and image forming apparatus equipped therewith

(75) Inventors: Kohji Yoshie, Tokyo (JP); Junichi Fujita, Tokyo (JP); Hiroyuki Wakabayas, Tokyo (JP); Tsuyoshi Tsuchiya, Tokyo (JP); Kenji Kawatsu, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA HOLDINGS, INC.

(21) Appl. No.: 10/749,400

(22) Filed: Jan. 2, 2004

(30) Foreign Application Priority Data
Jan. 7, 2003 (JP) 2003-000990
Jan. 7, 2003 (JP) 2003-000991

(51) Int. Cl. B42C 1/00

(52) U.S. Cl. 412/1

(57) ABSTRACT

A pasting and bookbinding apparatus having a sheet bundle loading device for positioning and stacking sheets ejected from an image forming apparatus, a holding device for holding a sheet bundle stacked on the sheet bundle loading device and transporting it, a sheet bundle transporting device for receiving the sheet bundle transported and interposing the sheet bundle to erect it, a paste coating device for coating paste on the back of the sheet bundle interposed and erected, a cover supplying device that supplies a cover sheet to a cover pasting device that presses the cover sheet supplied against the paste-coated back of the sheet bundle for pasting and a cover folding device for folding the cover sheet pasted on the sheet bundle along the edge portion of the paste applied back of the sheet bundle.

### BACKGROUND OF THE INVENTION

The present invention relates to a pasting and bookbinding apparatus that applies paste on the back of a sheet bundle formed by aligning sheets which have been subjected to image forming, to make a booklet by covering the back, the surface and the reverse of the bundle of sheets with a cover sheet, and in particular, to an image forming system equipped with a pasting and bookbinding apparatus which can be connected to an image forming apparatus such as a copying machine, a facsimile machine or a printer to be applied.

In general, a sheet on which an image is recorded by a main body of an image forming apparatus such as a copying machine, a facsimile machine, a printer or a multifunctional machine including functions of the preceding machines is processed in many ways such as, for example, punching holes, stapling, attaching a cover, folding, stamping or pasting and bookbinding, as sheet finishing.

Apparatuses used as a pasting and bookbinding apparatus include the following:

(1) A device to jet paste on a sheet by using a paste jetting nozzle;

(2) A device wherein a paste roller is installed in a paste container, and paste adheres to an outer circumference of the rotating paste roller to be transferred onto a sheet when the outer circumference of the rotating paste roller touches the sheet;

(3) A hot-melt coating device that jets a mixture containing hot-melt agents (heat fusing agents) and heated and compressed air from a nozzle; and

(4) A tape sticking device that sticks a tape on which adhesive paste is coated in advance on the back of a sheet bundle while the tape is heated.

In the method and the apparatus for pasting described in JP-A No. 7-80377, high-pressure air is blown against paste jetted from a paste jetting nozzle so that the paste is made to be a thin film.

In the bookbinding apparatus described in JP-A No. 59-500907, a sheet transported in the first direction is deflected to the second transport direction perpendicular to the first direction, and then, paste is applied linearly on the end portion of the running sheet for bookbinding by pressurizing after stacking and aligning.

As a method of bookbinding by sticking a tape on the back, there are known a method to stick a tape that is coated, in advance, with paste having adherence when it is heated, while the tape is heated, and a method to use a tape that is coated, in advance, with paste having adherence when it contains water. Conventional tape sticking devices are disclosed in JP-A No. 62-284795, U.S. Pat. No. 4,985,729 and JP-A No. 3-151286.

In the pasting and bookbinding apparatus disclosed in JP-A No. 7-80377, No. 59-500907, and No. 62-284795, U.S. Pat. No. 4,985,729 and JP-A No. 3-151286, a sheet loading means on which sheets in a bundle are loaded, a paste coating means, a cover attaching means, a cover folding means and a booklet ejecting means are arranged substantially in the horizontal direction, which has resulted in a total length of a pasting and bookbinding apparatus that is long and requires a broad floor space.

Since a section of driving mechanism of each of the aforementioned means cannot be operated except from the upper portion or from the side portion of a post-processing device, it has not been easy to conduct jam clearance for a sheet bundle and to conduct maintenance.

The pasting and bookbinding apparatus disclosed in JP-A No. 2002-326472 is one wherein a linear paste coating section is formed by a paste jetting means in the vicinity of side edge portion of a sheet under transport, to make a plurality of sheets to be stuck and to make a front cover and a back cover to be stuck to each other after they are superposed.

Each of the pasting and bookbinding apparatuses disclosed respectively in JP-A No. 7-80377 and No. 2002-326472 is one for conducting paste coating on each sheet under transport, and it has a problem that the time required for paste coating is long, a process to align paste-coated sheets by holding and superposing them is complicated, resulting in an irregular finish.

In pasting and bookbinding apparatuses of a tape sticking type disclosed in JP-A No. 62-284795, U.S. Pat. No. 4,985,729 and JP-A No. 3-151286, a paste coating device is stationary, and paste is coated on a sheet bundle when the bundle passes through the upper space of the paste coating device. In this paste coating device, a large space is needed for past coating, resulting in a large-sized pasting and bookbinding apparatus, which is not preferable as an image forming system to be provided side by side with an image forming apparatus.

### SUMMARY OF THE INVENTION

An object of the invention is to improve a pasting and bookbinding apparatus by solving the aforementioned problems and thereby to provide a pasting and bookbinding apparatus that is small in size and is easy to operate. Further object is to provide a pasting and bookbinding apparatus wherein quality of finish of bookbinding is improved and productivity of high speed processing is maintained and to provide an image forming system equipped with the pasting and bookbinding apparatus.

The objects stated above can be attained by either one of the following Structures (1)-(4) of the invention.

Structure (1): A pasting and bookbinding apparatus having a sheet bundle loading means on which sheets ejected from an image forming apparatus are positioned and stacked, a holding means that holds a sheet bundle stacked on the sheet bundle loading means and transports them, a sheet bundle transporting means that receives a sheet bundle transported by the holding means and interpose the bundle of sheets to erect it, a paste coating means that coats paste on the back of the bundle of sheets interposed and erected by the sheet bundle transporting means, a cover supplying means that supplies a cover sheet to a cover pasting means, a cover pasting means that presses a cover sheet supplied from the cover supplying means against the paste-coated back of the bundle of sheets for pasting and a cover folding means that folds a cover sheet pasted on a sheet bundle by the cover pasting means along the paste applied back of the bundle of sheets are arranged in a longitudinal line in the vertical direction inside the apparatus main body.

Structure (2): An image forming system characterized to be provided with an image forming apparatus main body composed of an image writing means, an image forming means and a sheet transporting means and with the pasting and bookbinding apparatus described in the aforementioned Structure (1).

Structure (3): A pasting and bookbinding apparatus having therein a sheet bundle loading means on which sheets ejected from an image forming apparatus are stacked, a sheet bundle transporting means having a holding means that transports a sheet bundle composed of plural sheets stacked on the sheet bundle loading means and holds the bundle of sheets to be erected at the prescribed position and a paste coating means having a movable paste coating member that coats paste on end surfaces of superposed bundles of sheets held at the prescribed position, wherein the paste coating member stands by at the initial position outside an area for the maximum-sized sheet, and moves along the end surfaces of superposed bundles of sheets held in the erected state to coat paste in the case of paste coating processing.

Structure (4): A pasting and bookbinding apparatus wherein there are provided a sheet bundle loading means on which sheets ejected from an image forming apparatus are stacked, a sheet bundle transporting means having a holding means that transports a sheet bundle composed of plural sheets stacked on the sheet bundle loading means and holds the bundle of sheets to be erected at the prescribed position, a paste coating means that stands by at the initial position outside an area in the lateral direction in the direction of end surfaces of superposed maximum-sized sheet bundles, and moves along end faces of superposed sheet bundles held in the erected state, in the case of paste coating processing to conduct paste coating processing, a cover supplying means that contains cover sheets which touch the surface and the back of the bundle of sheets and supplies them, a cover pasting means that brings a cover sheet to be in pressure contact with end surfaces of superposed sheet bundles which have been subjected to paste coating processing to paste the cover sheet and a cover folding means that folds a cover sheet pasted on the sheet bundle by the cover pasting means along the end faces of superposed bundles of sheets.

### BRIEF DESCRIPTION OF THE DRAWINGS

FIG. 1 is a entire structure diagram of an image forming system equipped with an image forming apparatus and a pasting and bookbinding apparatus.

FIG. 2 is a perspective view of an appearance of the image forming system.

FIG. 3 is a sectional view showing a sheet transport path of a pasting and bookbinding apparatus relating to the invention.

FIG. 4 is a sectional view of a pasting and bookbinding apparatus showing a transporting process for a sheet bundle and a cover.

FIG. 5 is a sectional view of a pasting and bookbinding apparatus showing a process of coating paste on a sheet bundle.

FIG. 6 is a top view of a paste coating means.

FIG. 7 is a side view of a paste coating means and a sheet bundle.

FIG. 8 is a perspective view of a paste coating means and a sheet bundle.

FIG. 9 is a sectional view of a pasting and bookbinding apparatus showing a process to stick a cover to a sheet bundle.

Each of FIGS. 10(a)-10(d) is a sectional view of a cover pasting means and a sheet bundle showing a process of folding a cover.

FIGS. 11(a) and 11(b) respectively show a perspective view of a sheet bundle on which a cover sheet is pasted, and a perspective view of a booklet which is made by conducting wrapping folding with a cover on a sheet bundle.

FIG. 12 is a sectional view of a pasting and bookbinding apparatus showing a process of ejecting a booklet composed of a sheet bundle and a cover.

FIG. 13 is a sectional view of a pasting and bookbinding apparatus showing a process of ejecting a booklet composed of a sheet bundle and a cover.

### DETAILED DESCRIPTION OF THE PREFERRED EMBODIMENT

Next, a pasting and bookbinding apparatus of the invention and an image forming system provided with the pasting and bookbinding apparatus will be explained as follows, referring to the drawings.

(Image Forming System)

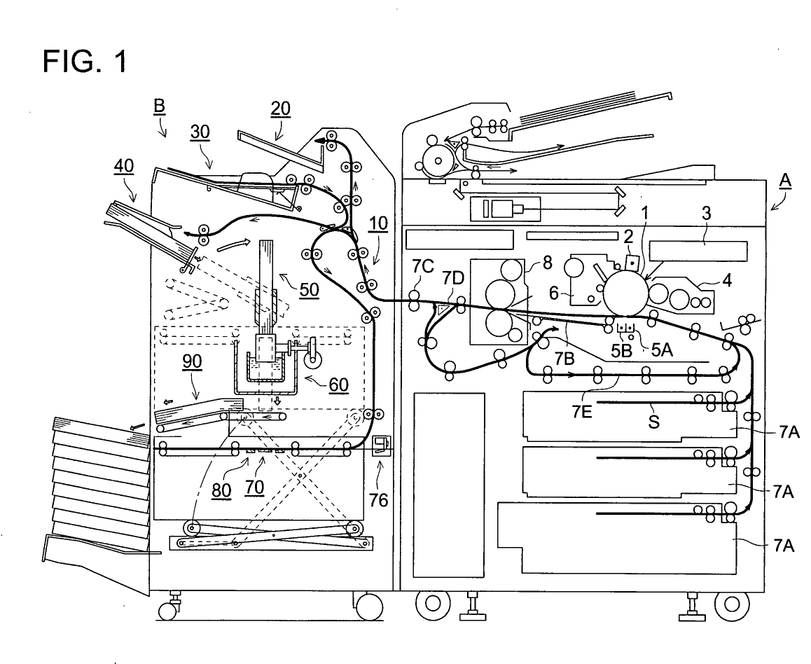

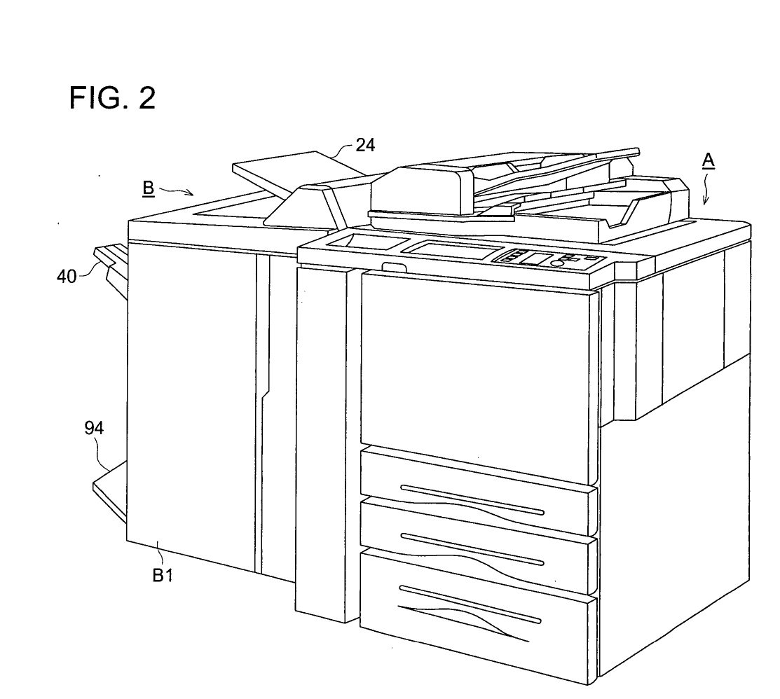

FIG. 1 is an entire structure diagram of an image forming system equipped with image forming apparatus A and pasting and bookbinding apparatus B, and FIG. 2 is a perspective view of an appearance of the image forming system.

(Image Forming Apparatus)

Image forming apparatus A has an image forming means wherein charging means 2, imagewise exposure means (writing means) 3, developing means 4, transfer means 5A, neutralizing means 5B and cleaning means 6 are arranged around rotary image carrier 1. In the image forming means, exposure scanning based on image data obtained from a document through reading by a laser beam of the imagewise exposure means 3 is conducted after a surface of the image carrier 1 is charged evenly by the charging means 2, to form a latent image, and the latent image is developed reversely by the developing means 4, and a toner image is formed on a surface of the image carrier 1.

Sheet S fed from sheet loading section 7A is transported to a transfer position. In the transfer position, the toner image stated above is transferred onto sheet S by the transfer means 5A. After that, charges on the reverse side of the sheet S is eliminated by the neutralizing means 5B and the sheet S is separated from the image carrier 1 to be transported by transporting section 7B, and then, is heated and fixed by fixing means 8 to be ejected from sheet ejection roller 7C.

When forming images on both sides of sheet S, sheet S subjected to heating and fixing by fixing means 8 is branched from an ordinary sheet ejection path by transport path changeover plate 7D, then, is reversed upside down through a movement in a form of a switchback in reversing transport section 7E, and passes the image forming section again so that an image is formed on the back of sheet S, and is ejected out of the apparatus from sheet ejection roller 7C through fixing means 8. Sheet S ejected from the sheet ejection roller 7C is fed into pasting and bookbinding apparatus B.

With respect to the surface of image carrier 1 after image processing, developing agents remaining on the surface are removed by cleaning means 6 so that the image carrier 1 turns out to be ready for the succeeding image forming.

(Pasting and Bookbinding Apparatus)

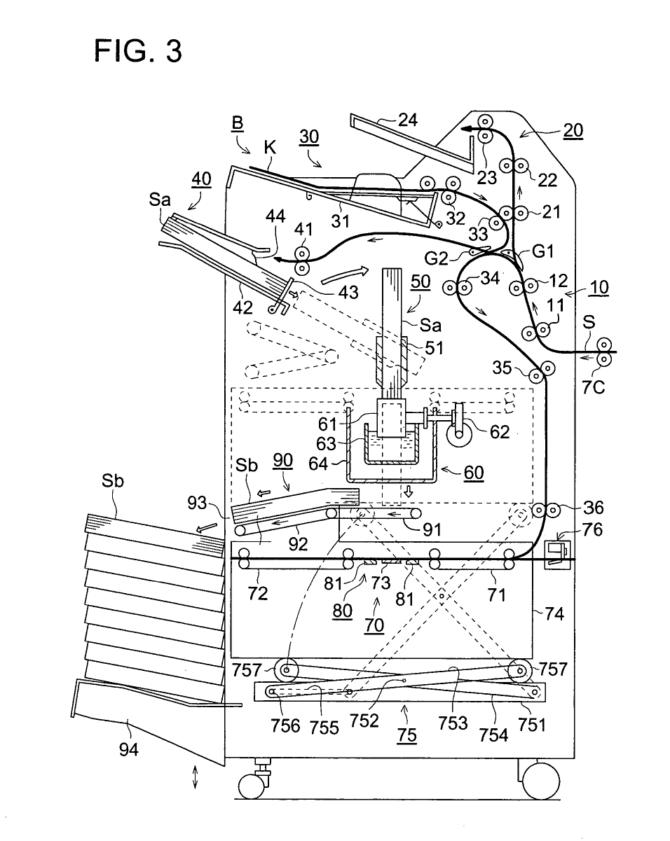

FIG. 3 is a sectional view showing a sheet transport path of pasting and bookbinding apparatus B relating to the invention.

Pasting and bookbinding apparatus B is composed of sheet transporting means 10, sheet ejection means 20, cover supplying means 30, sheet bundle loading means 40, sheet bundle transporting means 50, paste coating means 60, cover pasting means 70, cover folding means 80, and booklet ejection means 90. The respective means are arranged longitudinally and vertically in the main body of the pasting and bookbinding apparatus B.

<Sheet Transporting Means 10>

Sheet S that has been introduced into the sheet transporting means 10 is interposed between inlet rollers 11 and 12 to be transported, and is branched by transport path changeover means G1 to either one of the sheet ejection means 20 and the sheet bundle loading means 40.

<Sheet Ejection Means 20>

After the sheet transport is established, the transport path changeover means G1 intercepts a transport path leading to the sheet bundle loading means 40, and opens a transport path leading to the sheet ejection means 20.

Sheet S passing through a transport path leading to the sheet ejection means 20 is interposed between transporting rollers 21 and 22 to be transported upward, and is ejected by sheet ejection roller 23 on and housed in stationary sheet ejection tray (sub-tray) 24 located at the uppermost portion of the apparatus. On stationary sheet ejection tray 24, sheet S ejected from image forming apparatus A is directly received, and about a maximum of 200 sheets can be stacked thereon.

<Cover Supplying Means 30>

Sheet for cover (hereinafter referred to as cover) K housed in sheet feeding tray 31 of cover supplying means 30 is separated and fed by sheet feeding means 32, interposed by transporting rollers 33, guided downward by transport path changeover means G2 and interposed by transporting rollers 34, 35 and 36 to be transported to cover pasting means 70.

Incidentally, it is also possible to conduct pasting and bookbinding processing on an offline basis by loading cover K or sheet S in cover supplying means 30.

<Sheet Bundle Loading Means 40>

Sheet S branched to the left side in the drawing located at the downstream side in the sheet transport direction by transport path changeover means G1 and G2 is interposed by transporting rollers 41 to be housed at the prescribed position of sheet bundle loading means 40 and to be stacked thereon in succession, thus, sheet bundle Sa formed by prescribed number of sheets S is formed. The sheet bundle loading means 40 is composed of sheet placing table 42 that is arranged obliquely, rotatable sheet trailing edge positioning member 43 and sheet width aligning member 44 that aligns sheets in the sheet width direction.

<Sheet Bundle Transporting Means 50>

Sheet bundle Sa stacked on the sheet placing table 42 of sheet bundle loading means 40 is transported downward obliquely by an unillustrated pushing-out means. After that, the sheet bundle Sa is held by holding means 51 of the sheet bundle transporting means 50, and is turned while it is held so that the surface of the sheet bundle Sa to be subjected to paste coating processing may face downward, to be stopped at the prescribed position.

<Paste Coating Means 60>

Paste coating means 60 is composed of paste coating member (which is also called a coating roller) 61, rotating means 62 for the coating roller 61, paste container 63 that contains paste, movable body 64 that is movable from the rear surface side to the front surface side of pasting and bookbinding apparatus B while holding the paste container 63 and a moving means that reciprocates the movable body 64.

Incidentally, the paste coating member 61 is not limited to the coating roller, and a paste coating nozzle and an adhesive tape can also be applied.

<Cover Pasting Means 70>

Cover sheet pasting means 70 is composed of transporting belts 71 and 72 which receive cover K supplied from cover supplying means 30 to transport it and to stop it at the prescribed position, pressing member 73 that brings cover K into pressure contact with a paste-coated surface of sheet bundle Sa, movable casing 74 that supports the transporting belts 71 and 72 and the pressing member 73 and elevating means 75 that makes it possible for the movable casing 74 to move up and down vertically.

The elevating means 75 is supported on supporting stand 751, and is composed of two arms 753 and 754 which are pivoted on supporting shaft 752 rotatably, and intersect each other in an X-shaped form, movable shaft 756 capable of moving horizontally along elongated groove section 755 of the supporting stand 751 while being connected with a driving source and roller 757 that supports the movable casing 74.

When the movable shaft 756 is moved, upper end portions of the two arms 753 and 754 ascend to move the movable casing 74 to the upper position. In this ascended position (position shown with broken lines in FIG. 3), a central portion of cover K placed on the pressing member 73 is brought into pressure contact with the paste-coated surface of sheet bundle Sa to be stuck thereon.

Sheet-cutting means 76 arranged at the right side of the movable casing 74 in the drawing cuts cover K in a prescribed length in the direction for transporting cover K.

<Cover Folding Means 80>

Cover folding means 80 is provided over the cover pasting means 70. The cover folding means 80 has therein a pair of folding members 81 which are symmetrical bilaterally. The folding members 81 is movable in the direction of a thickness of sheet bundle Sa and is movable in the vertical direction. The folding members 81 folds cover K along a side edge of the paste-coated surface of the sheet bundle Sa, and superposes a front cover and a back cover respectively on the surface and the back of the sheet bundle Sa.

<Booklet Ejecting Means 90)

Booklet Sb wherein cover K is pasted on the paste-coated back portion of the sheet bundle Sa and a front cover and a back cover are formed is ejected out of the apparatus from ejection outlet 93 by two ejecting belts 91 and 92 of the booklet ejecting means 90, and is placed on elevating sheet ejection stand (booklet stacking means) 94 to be stacked in succession. After booklets Sb are ejected and stacked on the elevating sheet ejection stand 94, the elevating sheet ejection stand 94 descends successively.

<Front Door B1>

In FIG. 2, the symbol B1 represents a front door that opens and closes the front side of pasting and bookbinding apparatus B.

Front door B1 that opens and closes the front side of a main body of the pasting and bookbinding apparatus B is provided, so that front sides respective of cover supplying means 30, sheet bundle loading means 40, sheet bundle transporting means 50, paste coating means 60, cover pasting means 70, cover folding means 80 and elevating means 75 which are arranged lengthwise in a vertical direction in FIG. 3 may be opened and closed, and each means may be drawn out by means of a guide rail.

(Process of Pasting and Bookbinding With Cover)

<Transport of Sheet Bundle and Cover>

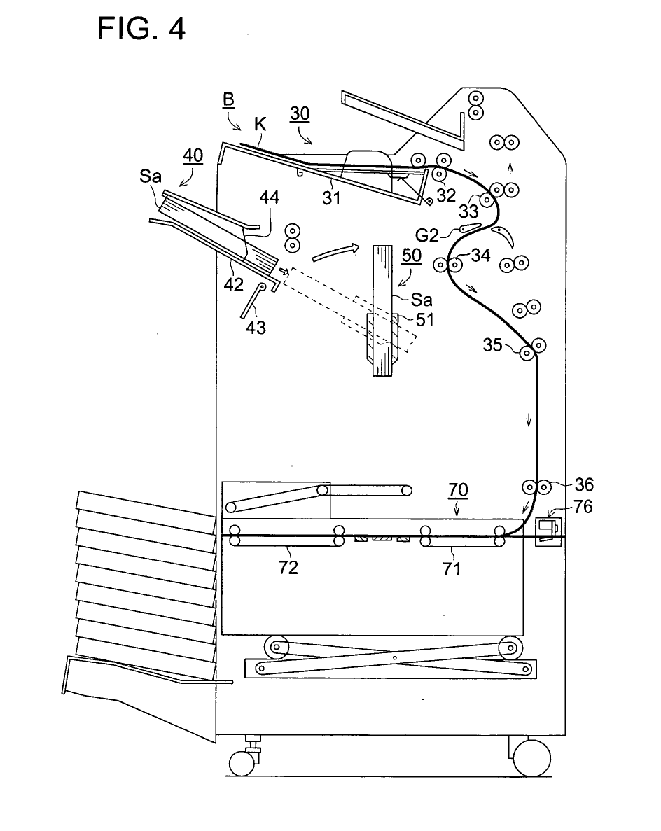

FIG. 4 is a sectional view of a pasting and bookbinding apparatus B showing a transporting process for a sheet bundle Sa and cover K.

Sheet bundle Sa composed of sheets S in a prescribed number stacked and aligned on sheet placing table 42 of sheet bundle loading means 40 are held by holding means 51. Sheet trailing edge positioning member 43 is swung by an unillustrated driving means, and retreats under sheet placing table 42. The holding means 51 holding sheet bundle Sa moves downward obliquely in the drawing, and rotates to be held in the erected state so that a surface to be subjected to paste coating processing on the sheet bundle Sa may face downward, and it stops at a prescribed position.

On the other hand, cover K loaded in sheet feeding tray 31 of cover supplying means 30 is separated sheet by sheet by sheet feeding means 32 to be fed, and is interposed by transporting rollers 33, then, is guided downward by transport path changeover means G2, and is interposed by transporting rollers 34, 35 and 36 to be transported by transporting belts 71 and 72 of cover pasting means 70, and is stopped at a prescribed position.

Sheet-cutting means 76 arranged at the right side of the transporting belt 71 in the drawing cuts cover K in a prescribed length in the direction for transporting cover K. Namely, since a length of cover K in its transport direction varies depending on a sheet size and a thickness of sheet bundle Sa, a wrapping length of cover K is calculated, and an excessive portion of cover K is cut by sheet-cutting means 76 in an optimum length prior to cover pasting, by inputting or detecting a sheet size, the number of sheets S and a thickness of sheet S in advance.

<Paste Coating on Sheet Bundle>

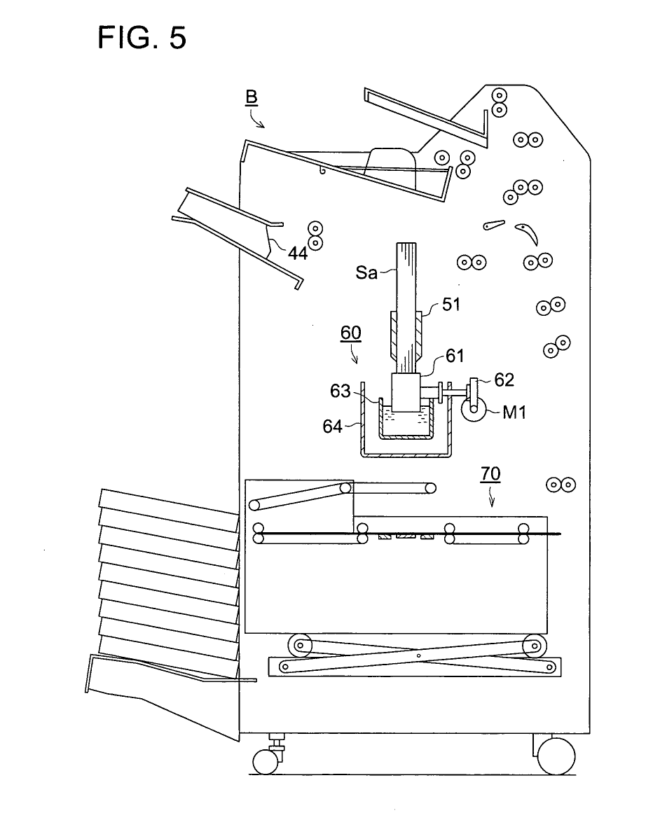

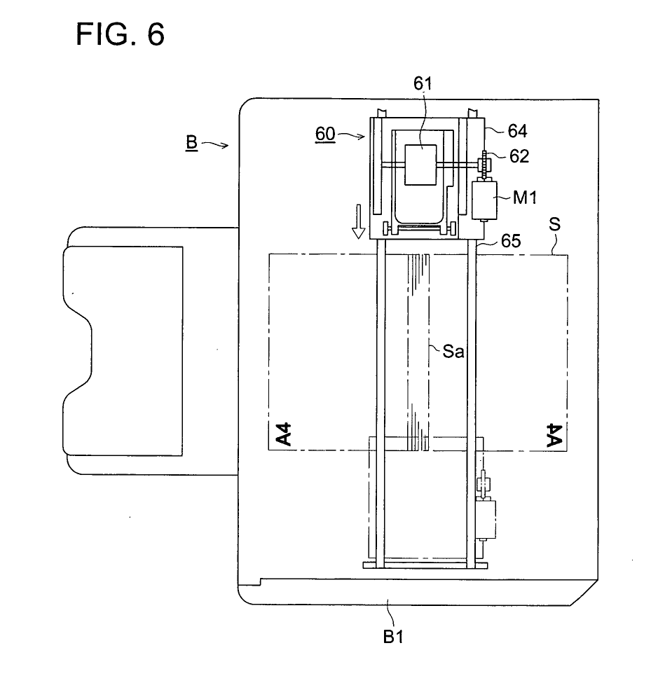

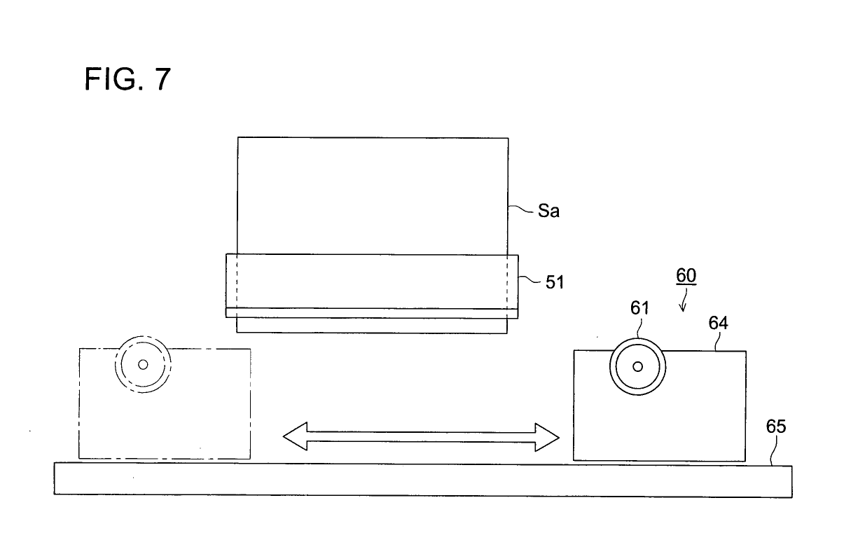

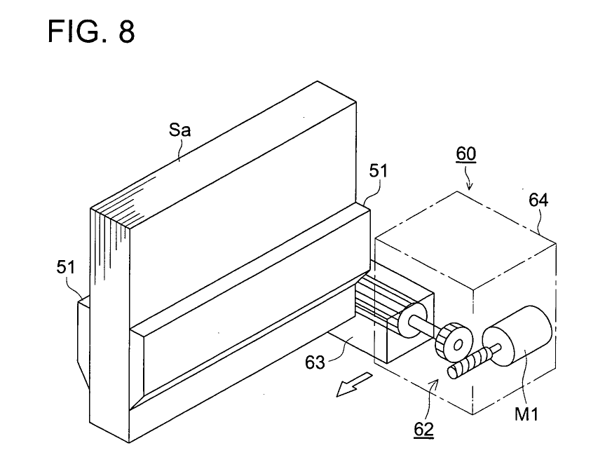

FIG. 5 is a sectional view of pasting and bookbinding apparatus B showing a process of coating paste on bundle of sheets Sa, FIG. 6 is a top view of paste coating means 60, FIG. 7 is a side view of paste coating means 60 and sheet bundle Sa and FIG. 8 is a perspective view of paste coating means 60 and sheet bundle Sa.

Movable body 64 of paste coating means 60 is moved by an unillustrated driving means in the direction that is in parallel with the longitudinal direction of a bottom surface of sheet bundle Sa held by holding member 51 in the erected state.

The movable body 64 starts moving from the initial position outside a sheet width area of a sheet in the maximum size, on the back side of pasting and bookbinding apparatus B, and is moved along guide member 65 to stop at a prescribed position on the front surface side of pasting and bookbinding apparatus B, and returns to the initial position after being driven to be reversed.

Coating roller 61 dipped in paste container 63 is rotated by motor M1 and rotating means 62. Forward movement or reciprocating movement of the movable body 64 makes coating roller 61 to coat paste in the longitudinal direction of the bottom surface of sheet bundle Sa held in the erected state.

<Adhesion Between a Sheet Bundle and a Cover>

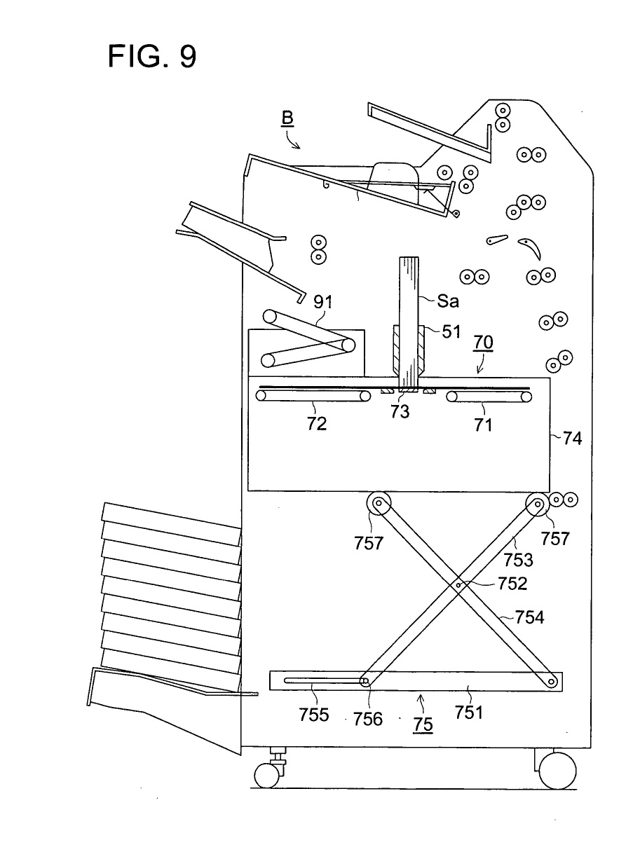

FIG. 9 is a sectional view of pasting and bookbinding apparatus B showing a process to stick cover K to sheet bundle Sa.

When movable shaft 756 of elevating means 75 is moved horizontally by an unillustrated driving means after completion of a process to coat paste on sheet bundle Sa, rollers 757 on the upper end portions of two arms 753 and 754 go up to move movable casing 74 to the upper position. In this upper position, a central portion of cover K placed on pressing member 73 is brought into pressure contact with a paste-coated surface of sheet bundle Sa to be stuck thereon.

Incidentally, ejecting belt 91 is rotated to retreat in advance of the ascent of cover pasting means 70, so that interference with sheet bundle Sa held in the erected state is prevented.

<Folding a Cover>

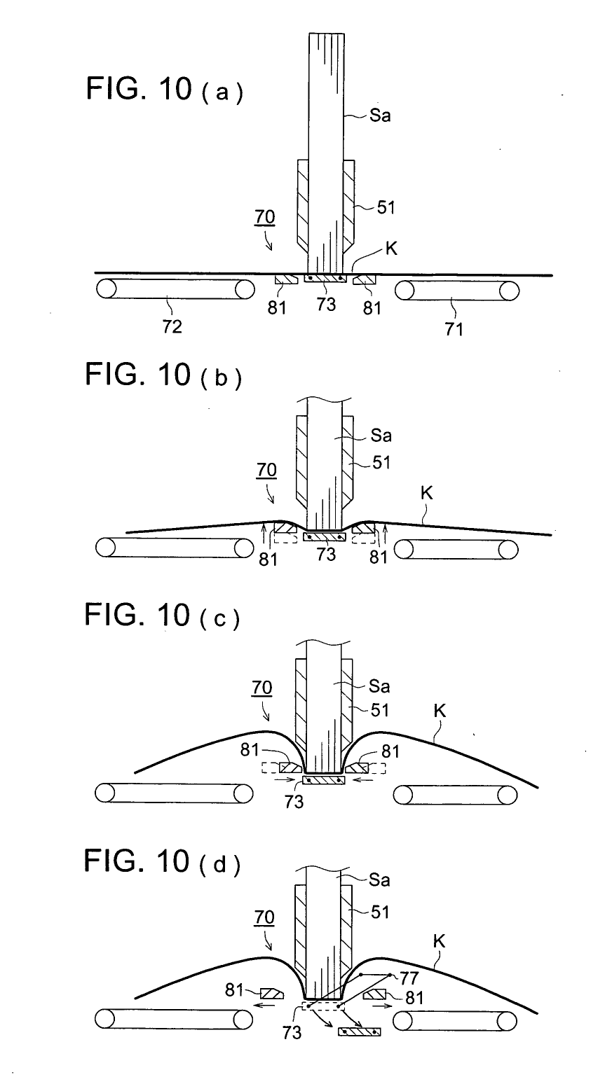

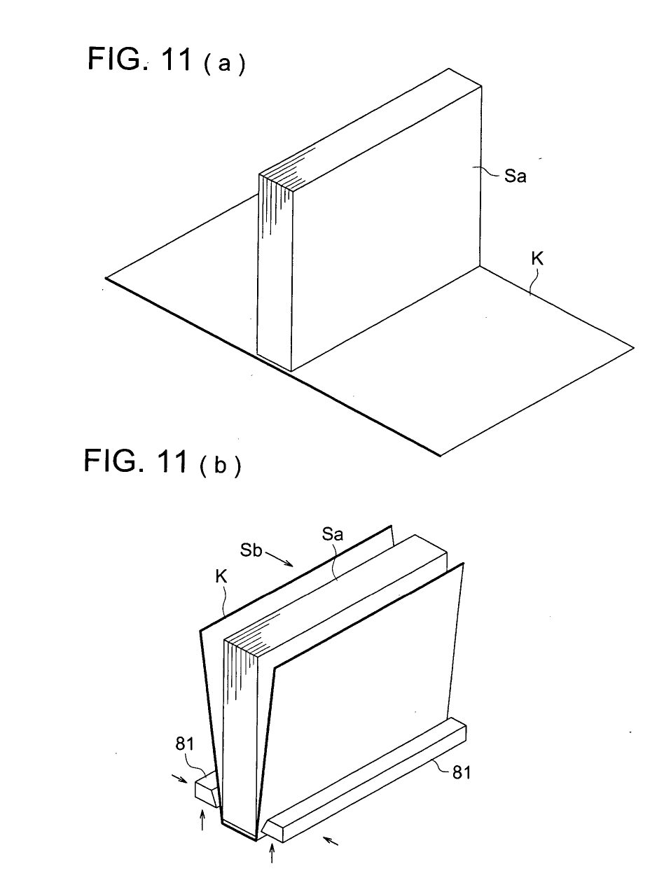

Each of FIGS. 10(a)-10(d) is a sectional view of cover pasting means 70 and sheet bundle Sa showing each process of folding cover K, and FIG. 10(a) shows a start of folding of a cover, FIG. 10(b) shows the middle of folding of a cover, FIG. 10(c) shows an end of folding of a cover and FIG. 10(d) shows release of pressure for folding of a cover, respectively. FIG. 11(a) is a perspective view of sheet bundle Sa on which cover K is pasted, and FIG. 11(b) is a perspective view of booklet Sb that is made by conducting wrapping folding with cover K on sheet bundle Sa.

After cover K is stuck to sheet bundle Sa, a pair of folding members 81 is driven by an unillustrated driving means in the state of an ascent of cover pasting means 70 shown in FIG. 9, to rise to be higher than the extended surface of the upper surface of pressing member 73, and moves from the position shown with broken lines in FIG. 10(b) to the position shown with solid lines. Due to the rising movement of the paired folding members 81, cover K is pushed up by the upper surface of the paired folding members 81, to be curved from the edge portion of a paste-coated surface of sheet bundle Sa.

After that, the paired folding members 81 move in the horizontal direction toward the paste-coated surface of sheet bundle Sa to press both sides of the sheet bundle Sa for forming, and forms booklet Sb (see FIG. 10(c)).

After completion of folding processing for cover K, the paired folding members 81 retreat from the folded portion of the cover K, and pressing member 73 is retreated downward by link mechanism 77 (see FIG. 10(d)).

<Ejection of a Booklet>

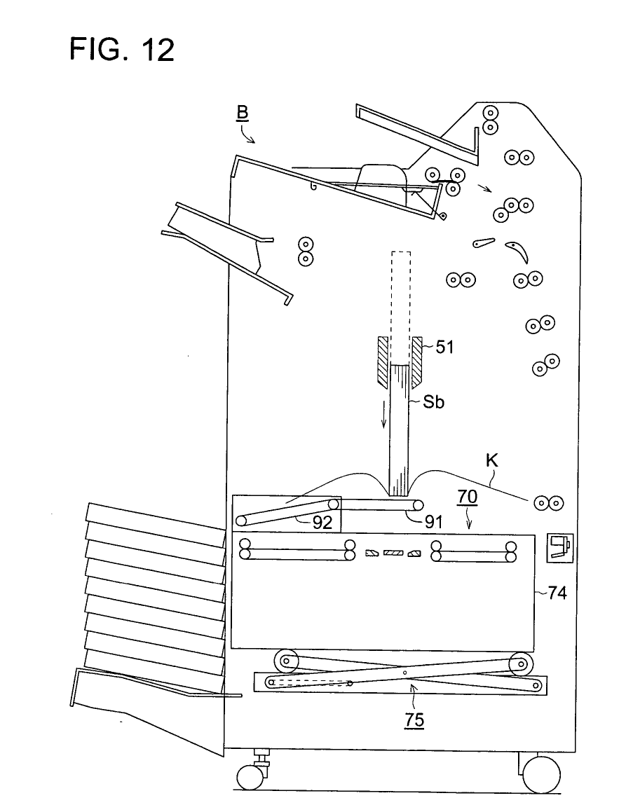

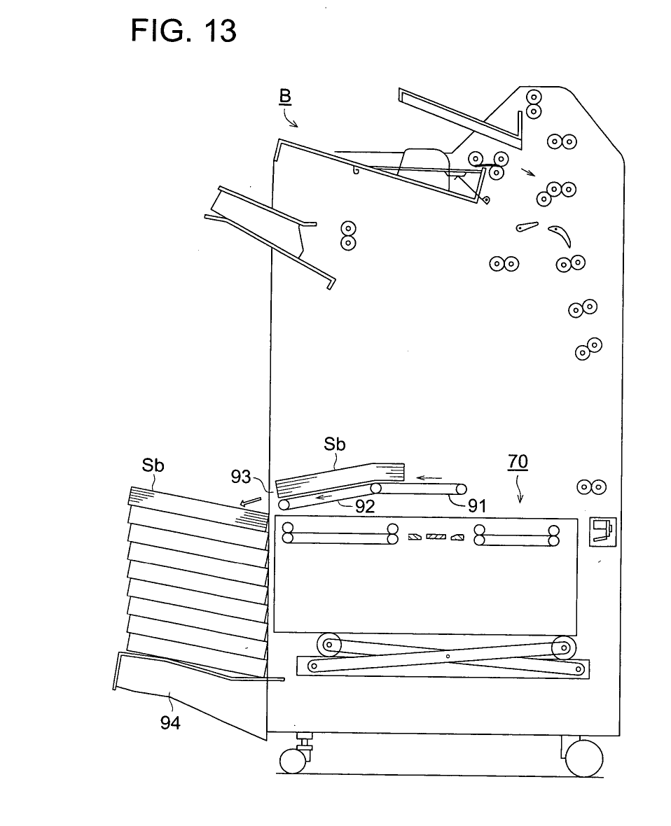

Each of FIGS. 12 and 13 is a sectional view of pasting and bookbinding apparatus B showing an ejecting process for booklet Sb composed of sheet bundle Sa and cover K.

After an end of a folding process for cover K, a descent of elevating means 75 makes cover pasting means 70 to descend.

After an end of a folding process for cover K, a descent of elevating means 75 makes cover pasting means 70 to descend to retreat, and then, ejecting belt 91 is rotated and stops at the position below booklet Sb. After that, when holding by holding means 51 is released, the booklet Sb descends and stops at the position where a lower back portion of the booklet Sb touches an upper surface of the ejecting belt 91 (see FIG. 12).

When rotations of ejecting belts 91 and 92 are started by an unillustrated driving means, the booklet Sb placed on the ejecting belts 91 and 92 is transported and is ejected out of the apparatus through ejection outlet 93 to be placed on elevating sheet ejection stand 94 (see FIG. 13).

In the pasting and bookbinding apparatus B in which cover supplying means 30, sheet bundle loading means 40, sheet bundle transporting means 50, paste coating means 60, cover pasting means 70 and cover folding means 80 are arranged lengthwise in a vertical direction in the main body of the apparatus as stated above, sheet bundle Sa stacked on sheet placing table 42 arranged in the upper portion is transported to be held and fixed vertically by holding means 51 so that paste is coated on the lower end portion of a sheet bundle by paste coating means 60, then, cover K is lifted upward vertically by elevating means 75 so that the cover K is brought into pressure contact with the lower end portion of the paste-coated sheet bundle, and then, folding member 81 is moved upward to fold the cover K and thereby to make booklet Sb with a cover, thus, pasting between sheet bundle Sa and cover K can be conducted surely in the vertical direction. It is further possible to make a floor space of pasting and bookbinding apparatus B to be minimum.

Incidentally, it is also possible to form the pasting and bookbinding apparatus B of the invention to be an independent apparatus, and to stack the sheet processed by another image forming apparatus on cover supplying means 30, and further to stack it on sheet bundle loading means 40 after interposing it with transporting rollers 33 and 41, to conduct pasting and bookbinding with paste coating means 60.

Further, it is also possible to form the pasting and bookbinding apparatus B of the invention to be an independent apparatus, to place the sheet processed by another image forming apparatus on sheet placing table 42 of sheet bundle loading means 40, and to load cover K on cover supplying means 30 to conduct pasting and bookbinding processing on an off-line basis.

As is clear from the above-mentioned explanation, the pasting and bookbinding apparatus and the image forming apparatus of the present invention are provided with the following effects.

(1) The pasting and bookbinding apparatus of the invention is one wherein a cover supplying means, a sheet bundle loading means, a holding means, sheet bundle transporting means, a paste coating means, a cover pasting means and a cover folding means are arranged lengthwise in a vertical direction in a main body of the pasting and bookbinding apparatus, and it is possible to make the structure of the apparatus to be small.

(2) Since a sheet ejection means is arranged in the upper portion of the pasting and bookbinding apparatus, the sheet which does not need to be subjected to pasting and bookbinding processing can be ejected directly without passing through a path for pasting and bookbinding, and it can be taken out promptly.

(3) It is possible to provide an elevating means in the lower portion of the pasting and bookbinding apparatus, and thereby to move a cover pasting means and a cover folding means in the vertical direction to make them to be brought into pressure contact with a paste-coated back of a sheet bundle, thus, a cover is brought into pressure contact with a fixed and supported sheet bundle accurately, and sure processing of bookbinding by wrapping with a cover is conducted, which makes it possible to manufacture booklets with high quality.

(4) Owing to formation of a transporting means that is composed of a sheet transport path through which a sheet ejected out of an image forming apparatus is transported and is fed into the sheet bundle loading means, a cover transport path through which a sheet for a cover supplied from the cover supplying means is transported to the cover pasting means and sheet ejection path through which a sheet is transported to the sheet ejection means, there is conducted sure processing of bookbinding with a cover including sheet transporting, cover transporting, sheet bundle transporting, paste coating, cover pasting and cover folding, and booklets with high quality can be manufactured.

(5) It is possible to make the structure of the apparatus to be small, by conducting forming of a sheet bundle by sticking between sheets with paste and processing of bookbinding by wrapping with a cover by which a booklet is made by sticking a cover composed of a front cover and a bock cover to a sheet bundle with paste, at the same location.

(6) When the front door of the pasting and bookbinding apparatus is opened, a cover supplying means, a sheet bundle loading means, a holding means, sheet bundle transporting means, a paste coating means, a cover pasting means and a cover folding means are exposed, so that maintenance of each means is easy.

(7) The image forming system equipped with the pasting and bookbinding apparatus of the invention makes it possible to conduct pasting processing that attains stable sheet transport and sheet aligning for the sheet ejected from the image forming apparatus main body at high speed, without lowering high productivity of the image forming apparatus main body, which makes it possible to conduct bookbinding continuously and automatically.

(8) In the pasting and bookbinding apparatus of the invention, the paste-coating member that coats paste on the back of a sheet bundle stands by at the initial position outside a sheet width area of a sheet in the maximum size, and conducts paste-coating processing, in the case of paste-coating processing, by moving along the back of the sheet bundle held in the erected state, which is different from conventional paste coating of a sheet bundle moving type, and a structure of the apparatus can be made small in size.

(9) In the pasting and bookbinding apparatus of the invention, the paste-coating member stands by at the initial position outside an area in the lateral direction that is perpendicular to the direction to supply the cover in the maximum size, and in the case of paste coating, the paste-coating member is moved along the back of the erected and fixed sheet bundle to conduct paste coating, and then, a sheet for a cover is brought by a cover pasting member into pressure contact with the back of the sheet bundle to be stuck, thus, a high quality booklet can be manufactured by sure processing of bookbinding by wrapping with a cover by means of paste coating and cover pasting.

(10) When the front side of the pasting and bookbinding apparatus is opened to draw out the movable paste coating means to this side, maintenance of the paste coating means can be conducted easily.

What is claimed is:

1. A pasting and bookbinding apparatus:
(a) a sheet bundle loading device for positioning sheets ejected from an image forming apparatus and stacking the positioned sheets thereon;
(b) a holding device for holding a sheet bundle stacked on the bundle of sheets loading device and transporting;
(c) a sheet bundle transporting device for receiving the sheet bundle transported by the holding device and interposing the sheet bundle to erect;
(d) a paste coating device for coating paste on a back of the sheet bundle interposed and erected by the sheet bundle transporting device;
(e) a cover supplying device for supplying a cover sheet;
(f) a cover pasting device for pressing the cover sheet supplied from the cover supplying device against a paste-coated back of the sheet bundle to paste; and
(g) a cover folding device for folding the cover sheet pasted on a sheet bundle by the cover pasting device along an edge portion of a paste-coated surface of the sheet bundle,
wherein elements (a) to (g) are arranged in a longitudinal line in a vertical direction inside a main body of the pasting and bookbinding apparatus.

2. The pasting and bookbinding apparatus of claim 1, further comprising a sheet ejection device arranged in an upper portion of a main body of the pasting and bookbinding apparatus, for directly ejecting a sheet which does not need to be subjected to pasting and bookbinding processing.

3. The pasting and bookbinding apparatus of claim 1, further comprising an elevating device provided in a lower portion of the pasting and bookbinding apparatus, for moving the cover pasting device and the cover folding device in a vertical direction.

4. The pasting and bookbinding apparatus of claim 2, further comprising a transporting device that is composed of a sheet transport path through which a sheet ejected from the image forming apparatus is transported and is fed into the sheet bundle loading device, a cover transport path through which a sheet for a cover supplied from the cover supplying device is transported to the cover pasting device and a sheet ejection path through which a sheet is transported to the sheet ejection device.

5. The pasting and bookbinding apparatus of claim 1, wherein formation of a sheet bundle by sticking between sheets with paste and bookbinding by wrapping with a cover by which a booklet is made by sticking a cover composed of a front cover and a back cover to a sheet bundle with paste, carried out at a same location.

6. The pasting and bookbinding apparatus of claim 1, wherein a booklet formed by the cover folding device is bookbinding by wrapping the sheet bundle with a front cover surface, a back cover surface and a back of the sheet bundle in which the paste applied portion back of the sheet bundle is pasted.

7. The pasting and bookbinding apparatus of claim 1, further comprising a front door for opening and closing a front side of a main body of the pasting and bookbinding apparatus, so that front sides respective of the cover supplying device, the sheet bundle loading device, the sheet bundle transporting device, the paste coating device, the cover pasting device, the cover folding device and an elevating device for moving the cover pasting device and the cover folding device in a vertical direction, which are arranged lengthwise in a vertical direction.

8. An image forming system comprising:
(a) an image forming apparatus main body including an image writing means, an image forming means and a sheet transporting means; and
(b) the pasting and bookbinding apparatus described in the claim 1.

9. A pasting and bookbinding apparatus comprising:
(a) a sheet bundle loading device for stacking sheets ejected from an image forming apparatus;
(b) a sheet bundle transporting device having a holding device for transporting a sheet bundle composed of plural sheets stacked on the sheet bundle loading device and holding the sheet bundle to be erected at a prescribed position; and
(c) a paste coating device having a movable paste coating member for coating paste on end surfaces of superposed sheet bundles held at the prescribed position,
wherein the paste coating member stands by at an initial position outside an area for a maximum-sized sheet, and moves along the end surfaces of superposed sheet bundle held in the erected state to coat paste when a paste coating processing is carried out.

10. A pasting and bookbinding apparatus comprising:
(a) a sheet bundle loading device on which sheets ejected from an image forming apparatus are stacked;
(b) a sheet bundle transporting device having a holding device for transporting a sheet bundle composed of plural sheets stacked on the sheet bundle loading device and holding the sheet bundle to be erected at a prescribed position;
(c) a paste coating device that stands by at an initial position outside an area in a lateral direction in a direction of end surfaces of a superposed maximum-sized sheet bundle, and moves along end faces of the superposed sheet bundle held in the erected state, when a paste coating processing is carried out;
(d) a cover supplying device that contains cover sheets which touch the surface and the back of the sheet bundle and supplies;
(e) a cover pasting device for bringing a cover sheet to be in pressure contact with end surfaces of superposed sheet bundle which ha been subjected to paste coating processing to paste the cover sheet; and
(f) a cover folding device for folding a cover sheet pasted on the sheet bundle by the cover pasting device along the end faces of superposed sheet bundle.

11. The pasting and bookbinding apparatus of claim 10, wherein a booklet formed by the cover folding device is bookbinding by wrapping the sheet bundle with a front cover surface, a back cover surface and the end faces of the superposed sheet bundle.
